(19) United States
(12) Patent Application Publication
(10) Pub. No.: US 2007/0150220 A1
(43) Pub. Date: Jun. 28, 2007

(54) Method for monitoring a technical device

(76) Inventor: Andreas Bode, Hochstadt (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/582,596

(22) PCT Filed: Nov. 26, 2004
(86) PCT No.: PCT/EP04/53112

§ 371 Date: Jun. 9, 2006

(30) Foreign Application Priority Data
Dec. 12, 2003 (EP) 03028711.4

(51) Int. Cl. G06F 19/00

(52) U.S. Cl. 702/84

(57) ABSTRACT

Disclosed is a method for monitoring a technical device, according to which a number of operational signals are detected during operation. A mean operation signal value is formed using said operation signals, and at least one standard operational signal is generated therefrom. The standard operational signal is ultimately compared to a reference value range of the respective operational signal.

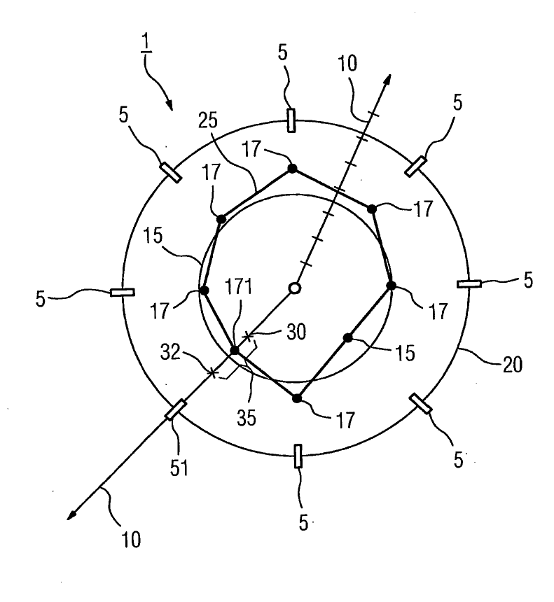

### CROSS REFERENCE TO RELATED APPLICATIONS

This application is the US National Stage of International Application No. PCT/EP2004/053112, filed Nov. 26, 2004 and claims the benefit thereof. The International Application claims the benefits of European Patent application No. 03028711.4 filed Dec. 12, 2003. All of the applications are incorporated by reference herein in their entirety.

### FIELD OF THE INVENTION

The invention relates to a method for monitoring a technical device, which method can be implemented on a computer basis especially in a diagnostic system.

### BACKGROUND OF THE INVENTION

Monitoring methods for technical devices are indispensable in complex technical systems in particular for ensuring reliable and safe operation. Sensors are provided in most known technical systems for detecting operational signals of the technical devices contained in the relevant system and for evaluating said signals in accordance with predefined criteria. As a rule, different types of operational signals occur, for example temperatures, pressures, currents, or voltages, which, moreover, usually arise not only in one technical device of the relevant technical system but in several. Furthermore, types of one operational signal, for example measured temperatures, can relate to different components of the technical device and hence have to be assessed using, in each case, different criteria accommodated to the respective component.

The monitoring of a technical device, or even of a complex technical system, therefore problematically involves a multiplicity of tasks with respect, in particular, to how suitable criteria are to be established for correctly assessing the measured values of the operational signals in terms of whether said values represent a normal, desired operation of the technical device, or whether action needs to be taken in order to change the technical device's operational status or effect a repair.

Methods are known according to the prior art where the operational signals of the technical device are monitored for the violation of absolute thresholds. Said absolute thresholds can represent, for instance, an operating limit of the technical device beyond which limit it can be assumed that the device will be destroyed owing to excessive loading.

What is disadvantageous therein is that the monitoring function does not respond until an operational signal value has already departed substantially from standard operation and approached an absolute threshold. The absolute thresholds are, however, usually far removed from the technical device's desired, standard operation so that although said known monitoring method can indeed prevent damage to the technical device, minor, though still undesired, deviations from a desired standard operation will go undetected.

Other monitoring methods are also known that use diagnostic systems in which complex mathematical techniques are implemented such as, for instance, regression analysis or neural networks for analyzing the current values of the operational signals and making inferences about the current operating status.

Expected values that are subsequently compared with the values actually measured are therein determined for the operational signals by means of mathematical techniques.

Disadvantageous therein are chiefly the high development costs of methods of said type and the lack of transferability to other technical devices. Known methods of such type must be tailored very specifically and labor-intensively to the technical device requiring to be monitored in each case.

### SUMMARY OF THE INVENTION

The object of the invention is therefore to disclose a simple method for monitoring a technical device, which method in particular surmounts the cited disadvantages and guarantees that the technical device will operate with a high degree of operational reliability similarly to when the known, more complex methods are employed.

Said object is achieved according to the invention by means of a method comprising the following steps for monitoring a technical device:
1. A number of operational signals of the technical device are detected while said device is operating.
2. A mean operational signal value is formed using at least some of the operational signals from the number thereof.
3. A normalized operational signal containing a deviation of a current value of the operational signal from the mean operational signal value is formed for at least one operational signal, and
4. said normalized operational signal is compared with a reference value range of the relevant operational signal.

The invention proceeds from the notion that a normalizing of operational signals requiring to be monitored will allow the respective operational signal to be assessed better than when the operational signal's absolute value is considered. A normalized value for an operational signal contains more information than said operational signal's mere absolute value. For example, a normalized operational signal value of 0° C. means that the temperature being observed is just as high as the mean value for all temperatures being monitored in terms of a monitoring location or a component of the technical device. This allows an initial inference to be made, solely from knowing the normalized operational signal value, that the operational signal value being observed is very probably within a normal range.

Merely considering an absolute value generally provides no information about that.

Normalized operational signals furthermore have the advantage that their value range is not subject to such divergent spreading as the underlying absolute values. Said normalized operational signals consequently do not display such wide fluctuations as the associated absolute values, and observing and assessing a trend in the operational signal values is greatly simplified by way of evaluating the corresponding normalized operational signal values.

The mean operational signal value can therein include an arithmetic or geometric mean value of the operational signals being observed; other definitions for determining a mean value are also conceivable.

The reference value range is formed in an advantageous embodiment by means of a lowest and a highest value of the normalized operational signal.

The value of an operational signal being observed is as a rule prone to fluctuate to a certain degree while the technical device is operating. After a sufficiently long period of observation a lowest and a highest value of the operational signal's normalized value can be specified that can be assigned to a standard operation as operating limits. If normalized operational signal values lying outside said reference value range are subsequently obtained, that will give a strong indication of an operational status of the technical device—in terms of the operational signal being observed—that is not within the desired standard operation. A tolerance band can additionally be provided around the reference value range to prevent monitoring from responding too keenly.

The lowest and/or highest value of the normalized operational signal can therein be determined either from actual measured values of the relevant operational signal or, alternatively, using a statistical distribution function.

The latter embodiment offers the advantage of rendering a test phase of longer duration for determining the lowest and highest value unnecessary, said values instead being determined statistically on the basis of, for example, a standard distribution using distribution parameters accommodated to the respective application.

In a particularly advantageous embodiment the reference value range is determined several times while the technical device is operating and the normalized operational signal is compared with the current reference value range in each case.

In said embodiment a learning process takes place with regard to the reference value range which, owing to the increasing number of operational signal values available, is better matched to the technical device's operation.

The current reference value range in each case will then be used at each instant during monitoring so that monitoring will not have to await completion of the learning process before starting but can do so practically from the time the technical device starts operating, and with increasing quality.

The quality of the current reference value range increases therein inasmuch as changes can occur in terms of the normalized operational signal's lowest and highest value that are undetectable when the reference value range is determined once only. For example, the temperature of the flame in an operating burner can vary slightly up or down owing to chance influences without the burner's desired standard operation being adversely affected thereby. Allowance is made for this in the present embodiment by appropriately adjusting the lowest and/or highest value of the normalized operational signal in order to prevent monitoring from responding too keenly and needlessly.

If is further advantageous for the operational signal's current value additionally to be compared with a monitoring threshold specified in advance.

The monitoring threshold therein represents an operating limit which is already known from the technical device's basic operating conditions and/or physical design and must not be violated while the technical device is operating. The specific issue may be, say, a permissible maximum temperature that must not be exceeded.

If, in the fundamental inventive method, brief effects that are negligible for standard operation or chance disruptions during signal detection, for example, should cause a reference value range to be determined which includes a lowest and/or highest value that violates the pre-specified monitoring threshold, then additional monitoring of the operational signal for said pre-specified monitoring threshold can provide assurance that the above-cited operating limit will not be exceeded.

In a further embodiment a corresponding mean operational signal value is formed for operational signals of each type.

As mentioned at the beginning, operational signals of differing type often occur in a technical device, relating, for example, to temperatures, currents, voltages, flows etc.

Each type can therein in turn be assigned to different components of the technical device. For example, bearing and housing temperatures can be registered in an engine which, while both being ‘temperature’ in type, each relate to a different component of the technical device.

It is now provided in the present embodiment for a mean operational signal value to be formed in each case separately at least for the operational signals of the same type, with the possibility of providing further subdivisions relating to the technical device's different components.

Monitoring of each component of the technical device is carried out particularly advantageously using an inventive method in each case, with the respective mean operational signal value being determined separately for each component of the technical device and for said component's operational signals of each type.

### BRIEF DESCRIPTION OF THE DRAWINGS

An exemplary embodiment of the invention is presented in more detail below with reference to the drawing, in which:

FIGURE shows a technical device embodied as a combustion chamber of a gas turbine for illustrating the inventive method.

### DETAILED DESCRIPTION OF THE INVENTION

The FIGURE shows a cross-sectional view of a technical device 1 embodied as a combustion chamber of a gas turbine.

In the cross-sectional plane shown the combustion chamber therein contains sensors 5, 51 arranged circumferentially on the combustion chamber wall 20. Said sensors 5, 51 are therein assigned to burners, not shown in more detail, and are intended to detect said burners' respective flame temperature.

A mean operational signal value 15 is formed from the values of operational signals detected by means of the sensors 5, 51.

For improved clarity of presentation and of spatial assignment to the burners, the FIGURE shows the determined mean operational signal value 15 as a circular equipotential line around a central point of the cross-section of the combustion chamber.

A normalized operational signal 17, 171 is in each case formed for each operational signal of each burner 5, 51, with the respective actual measured temperature value of the relevant operational signal being reduced by the mean operational signal value 15 so that the normalized operational signals 17, 171 in each case represent a deviation from the mean operational signal value 15.

Instead of the cited subtraction of the mean operational signal value 15 from the actual measured values for the corresponding operational signals, the actual measured values can also be proportioned to the mean operational signal value 15 to give a quotient representing the deviation of the actual measured value from the mean operational signal value 15.

The FIGURE further shows a value axis 10 indicating the direction of increasing temperature values so that a temperature profile 25 of the combustion chamber can be shown with the aid of the normalized operational signals 17, 171.

Respective lowest 30 and highest values 32 for the relevant normalized operational signal 17, 171 are obtained for each sensor 5, 51 while the combustion chamber is operating. Said lowest 30 and highest value 32 together define a reference value range 35.

The temperature profile 25 is a momentarily or, rather, briefly observed temperature distribution in the cross-section of the combustion chamber and is consequently prone to change while the combustion chamber is operating, for example as a result of changes in the fuel and/or air supply, load variations, faults in a burner etc.

In contrast thereto, the lowest value 30 and the highest value 32 are not momentary or brief snapshots but, instead, are lowest or, as the case may be, highest operational signal values that have been determined over a period of operation and which with a high degree of probability represent a standard operating range of the combustion chamber.

The lowest value 30 and the highest value 32 are in each case preferably determined separately for each operational signal because, as a rule, the components generating the relevant operational signal are individually not completely identical to the other relevant components so that a different, albeit perhaps only slightly different, reference value range 35 needs to be formed for each operational signal.

For improved clarity of presentation only one of said reference value ranges 35 is shown in the FIGURE.

1-7. (canceled)

8. A method for monitoring a technical device, comprising:
detecting a plurality of operational signals of the technical device;
determining a mean operational signal value using at least some of the operational signals;
determining a normalized operational signal for at least one operational signal where the normalized operational signal contains a deviation of a current value of the operational signal from the mean operational signal value; and
comparing the normalized operational signal with a reference value range of the relevant operational signal.

9. The method as claimed in claim 8, wherein the reference value range is the range between a lowest and a highest value of the normalized operational signal.

10. The method as claimed in claim 9, wherein the lowest or highest value of the normalized operational signal are determined from actual measured values of the relevant operational signal.

11. The method as claimed in claim 10, wherein the lowest and highest value of the normalized operational signal are determined from actual measured values of the relevant operational signal.

12. The method as claimed in claim 11, wherein the lowest or highest value of the normalized operational signal are determined using a statistical distribution function.

13. The method as claimed in claim 12, wherein the lowest and highest value of the normalized operational signal are determined using a statistical distribution function.

14. The method as claimed in one of the claims 13, wherein the reference value range is determined and the normalized operational signal is compared with the current reference value range while the technical device is operating.

15. The method as claimed in one of the claims 14, wherein the reference value range is determined multiple times while the technical device is operating and the normalized operational signal is compared with the current reference value range for each determination of the reference value range.

16. The method as claimed in one of the claims 15, wherein the current value of the operational signal is compared with a predetermined monitoring threshold value.

17. The method as claimed in claim 16, wherein a corresponding mean operational signal value is determined for each type of operational signals.

18. The method as claimed in claim 17, wherein the technical device is a gas turbine engine.

19. The method as claimed in claim 18, wherein the operational signals are selected from the group consisting of: a temperature signal, a pressure signal, a electrical current signal, and an electrical voltage signal.

20. The method as claimed in claim 19, wherein the operational signals are combustion chamber burner flame temperature signals.

21. A method for monitoring a combustion chamber burner flame temperature of a gas turbine engine, comprising:
detecting an operational signal of the gas turbine engine that corresponds to the combustion chamber burner flame temperature of the gas turbine engine;
determining a mean operational signal value of the detected operational signal;
determining a normalized operational signal based on the detected operational signal where the normalized operational signal contains a deviation of a current value of the operational signal from the mean operational signal value;
comparing the normalized operational signal with a reference value range of the detected operational signal where the reference value range is determined multiple times while the gas turbine engine is operating and the normalized operational signal is compared with the current reference value range for each determination of the reference value range; and
comparing the current value of the detected operational signal with a predetermined monitoring threshold value.
